(19) United States
(12) Patent Application Publication
(10) Pub. No.: US 2018/0267077 A1
(43) Pub. Date: Sep. 20, 2018

(54) Fiber-Optic Accelerometer

(71) Applicant: Siemens Aktiengesellschaft, Muenchen (DE)

(72) Inventors: Thomas Bosselmann, Marloffstein (DE); Michael Villnow, Fuerth (DE)

(73) Assignee: Siemens Aktiengesellschaft, Muenchen (DE)

(21) Appl. No.: 15/758,444

(22) PCT Filed: Sep. 6, 2016
(86) PCT No.: PCT/EP2016/070947

§ 371 Date: Mar. 8, 2018

(30) Foreign Application Priority Data
Sep. 11, 2015 (DE) 10 2015 217 434.4

(51) Int. Cl. G01P 15/093; G01D 5/26

(52) U.S. Cl. CPC G01P 15/093; G01D 5/268

(57) ABSTRACT

The present disclosure relates to accelerometers. Various embodiments of the teachings thereof may be used in a generator. For example, a fiber-optic accelerometer may include: an optical fiber having a free end which vibrates under the influence of acceleration; a light source emitting light into the optical fiber at an opposite end of the fiber; a mirror arranged to reflect a portion of the light back into the optical fiber; and a detection device receiving reflected light at the opposite end of the fiber. The optical fiber may comprise a double-cladding fiber including a core, an internal cladding, and an external cladding.

### CROSS-REFERENCE TO RELATED APPLICATIONS

This application is a U.S. National Stage Application of International Application No. PCT/EP2016/070947 filed Sep. 6, 2016, which designates the United States of America, and claims priority to DE Application No. 10 2015 217 434.4 filed Sep. 11, 2015, the contents of which are hereby incorporated by reference in their entirety.

### TECHNICAL FIELD

The present disclosure relates to accelerometers. Various embodiments of the teachings thereof may be used in a generator.

### BACKGROUND

Generators typically used in power plants tend to experience vibrations at twice the mains frequency in the region of the end winding. If the amplitudes of the bar vibrations are too high, the insulation or the copper can become damaged, which may make maintenance of the generator necessary. Since the end winding is at a high voltage potential, fiber-optic accelerometers (FOA) are increasingly used to monitor such vibrations.

The accelerometer known from DE 10 2010 019 813 A1 uses the approach of converting the deflection of a free end of an optical fiber to an intensity change of a light signal by directing the free end of the fiber onto a tilted mirror. In this sensor principle, the resonance frequency of the sensor is defined by the modulus of elasticity, the geometrical moment of inertia, the density and the length of the free fiber, among other factors. The sensitivity of the sensor corresponds to the deflection at the fiber end and is described by the same parameters. The relationship between the resonance frequency and the deflection/sensitivity of the sensor is indirectly proportional, i.e. an increased resonance frequency reduces the deflection at the fiber end, an increase in sensitivity conversely reduces the resonance frequency of the sensor.

### SUMMARY

The teachings of the present disclosure may be embodied in a fiber-optic accelerometer with an increased sensitivity without an opposing reduction in the resonance frequency. For example, a fiber-optic accelerometer (10) may include: an optical fiber (11) having a free end, wherein the free end can be caused to vibrate under the influence of acceleration, a light source for emitting visible, ultraviolet or infrared light into the optical fiber (11) at an end of the fiber (11) that is remote from the free end, a mirror (14) arranged to reflect a portion of the light exiting the free end into the optical fiber (11), and a detection device for receiving reflected light at the end of the fiber (11) that is remote from the free end. The optical fiber (11) may comprise a double-cladding fiber having a core (30), an internal cladding (31), and an external cladding (32).

In some embodiments, the numerical aperture of the core (30) ranges from 0.075 to 0.14, and the numerical aperture of the internal cladding (31) ranges from 0.22 to 0.5.

In some embodiments, the core (30) of the optical fiber (11) contains a Bragg grating in the free end.

In some embodiments, the core (30) and the internal cladding (31) of the optical fiber (11) are configured as multi-mode waveguides.

In some embodiments, the length of the free end is between 12 and 18 mm, in particular between 15 and 17 mm.

In some embodiments, the termination surface of the free end is formed by a fraction of the optical fiber (11) that is at an angle of between 5° and 18°, in particular between 12° and 18°, with respect to the plane that is perpendicular to the fiber axis.

In some embodiments, the tilting axes of the fracture of the optical fiber (11) and of the mirror (14) with respect to the plane perpendicular to the fiber axis are oriented to be parallel with respect to one another.

In some embodiments, the distance between the fiber termination surface and the mirror (14) is between 25 μm and 75 μm.

In some embodiments, only the own weight of the optical fiber (11, 35, 50) is used as oscillating weight.

Some embodiments may include an electrical machine, in particular a generator, having at least one fiber-optic accelerometer (10) as described above.

### BRIEF DESCRIPTION OF THE DRAWINGS

Various embodiments of the teachings herein which are not restrictive in any way will now be explained in more detail with reference to the figures of the drawing. Here, the features are illustrated in schematic fashion and not necessarily to scale. In the figures:

FIG. 1 shows a fiber-optic accelerometer having a glass fiber and a mirror, according to teachings of the present disclosure;

FIG. 2 shows a section of the fiber-optic accelerometer in an enlarged illustration;

FIG. 3 shows a section through the first glass fiber.

### DETAILED DESCRIPTION

In some embodiments, the fiber-optic accelerometer comprises an optical fiber having a free end, wherein the free end is caused to vibrate under the influence of acceleration. The resulting vibrations are detected and then interpreted as a measure of the acceleration. In some embodiments, the accelerometer comprises a light source for emitting visible, ultraviolet, or infrared light into the optical fiber at an end of the fiber that is remote from the free end, a mirror arranged to reflect a portion of the light exiting the free end into the optical fiber, and a detection device for receiving reflected light at the end of the fiber that is remote from the free end. In some embodiments, the optical fiber comprises a double-cladding fiber, also referred to as DCF (double-clad fiber).

The light reflected at the mirror is incident on the fiber end surface and also coupled in and guided here by the internal cladding (the second, larger core) with a greater numerical aperture at significantly greater angles than with a simple optical fiber. This makes possible a stronger tilting of the mirror, as a result of which the sensitivity of the sensor is increased, without producing strong input coupling losses. In some embodiments, the light is guided in the core of the optical fiber to the free end, because in this case the emission angle is small, which allows the reflected beam to remain spatially more limited and in turn minimizes the losses during the later coupling into the optical fiber.

In some embodiments, the double-cladding fiber comprises a core, an internal cladding, and an external cladding. The core and the internal cladding may comprise multi-mode waveguides; a higher signal quality is achievable in this way than with single-mode wave guidance. In some embodiments, the core has a lower numerical aperture than the internal cladding. For example, the core can have a numerical aperture of 0.075 to 0.14, while the internal cladding has a numerical aperture of between 0.22 and 0.5.

In some embodiments, the core of the optical fiber includes a Bragg grating in the free end. This Bragg grating may be used to measure the temperature of the sensor in the region of the free end. Signal errors caused by temperature changes can hereby be corrected in a computational manner. The Bragg grating may be near the free end of the optical fiber, for example within the 25% of the optical fiber closest to the fiber termination of the free end of the fiber. The detection device may comprise means for ascertaining the reflection wavelength of the Bragg grating that is a measure for the temperature. To this end, the reflected component of radiation that has been coupled into the core is spectrally analyzed in a manner known for Bragg gratings. In some embodiments, the core of the optical fiber comprises a single-mode core; enabling simplified evaluation of the Bragg grating signal.

Values for the core of the optical fiber can be, for example, 50 μm or 62.5 μm as a multi-mode core, or for example 25 μm as an intermediate value, so-called few mode. The internal cladding as multi-mode core can have both standard values such as 62.5 μm for the case of a single-mode core and greater diameters such as for example 200 μm or 400 μm.

In some embodiments, to keep the resonance frequency sufficiently high with respect to the operating frequency, typically 400 Hz, the length of the fiber may be appropriately small. However, for a high sensitivity, the accelerometer may include as large a fiber length as is possible. In some embodiments, a fiber length of between 12 and 18 mm is used for the free end for a standard multimode fiber 62/125 μm. In particular, a fiber length of between 15 and 17 mm is selected. In some embodiments, the fiber length is 16 mm.

In some embodiments, only the own weight of the optical fiber is used as the oscillating weight.

In some embodiments, to prevent back reflections at the termination surface of the optical fiber, an 8° fracture of the end surface is used. The azimuthal orientation of the fiber end relative to the mirror may be chosen such that the fracture and the mirror surface enclose the maximum angle possible. In other words, fracture and mirror surface form the shape of a “V.” Due to the oblique termination surface, the light is refracted slightly downwardly from the fiber—downwardly with respect to the shape of the “V”—by approximately 3.5°. As a result, the effective angle of incidence on the mirror is reduced.

In some embodiments, the mirror is tilted by between 9° and 13°. The azimuthal orientation of the fiber end relative to the mirror may be chosen such that the fracture and the mirror surface enclose the maximum angle possible. In other words, fracture and mirror surface form the shape of a “V.” In particular embodiments, the mirror is tilted by 11°.

In some embodiments, the mirror and the fiber end may be arranged relative to one another such that the enclosed angle is minimized.

In other words, the oblique mirror surface and the fracture form an arrangement in the manner of a parallelogram.

In some embodiments, the distance between the glass fiber and the mirror is between 25 and 75 μm. With the described configuration, a relatively linear sensor characteristic line between acceleration values of 0 and 10 g with a sensitivity of approximately 1%/g is advantageously obtained.

In some embodiments, to simplify the setup, all elements of the sensor head may have a cylinder-symmetric configuration. The cylindrical sensor may then be inserted into a rectangular block. The supply line is, for example, a Teflon tube of 3-5 mm diameter, in which the glass fiber is loosely laid. At the end of the supply line is a plug for optical waveguides, for example of type FC-APC or E-2000.

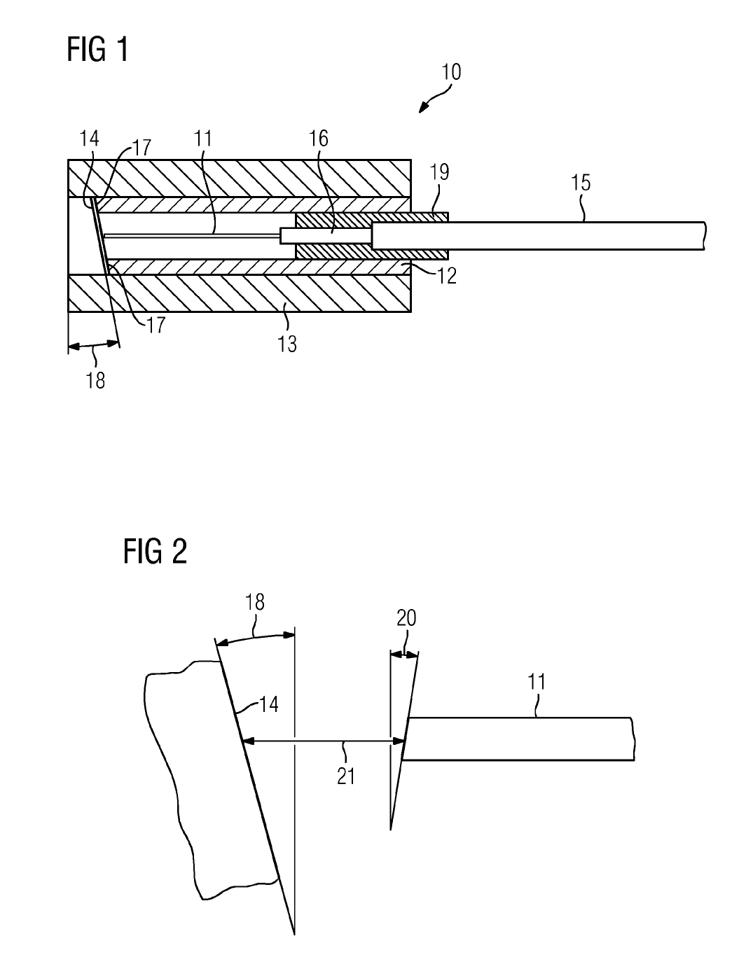

The fiber-optic accelerometer 10 shown in FIG. 1 comprises a glass fiber 11. The latter may comprise a double-cladding fiber. A section of the glass fiber 11 of 16 mm length is free-standing. The glass fiber 11 terminates at the end of said section. Adjoining the free-standing section, the glass fiber 11 may be fixed in a guide element 16. In some embodiments, the glass fiber 11 is loosely guided in a Teflon tube 15 having a 3.7 mm diameter.

The end of the Teflon tube 15 is enclosed, together with the guide element 16, by a first sleeve 19. A second sleeve 12 wraps around the first sleeve 19. The second sleeve 12 extends from the region of the first sleeve over the free section of the glass fiber 11. At the end face where the glass fiber 11 terminates, the second sleeve 12 has a termination that is chamfered at an angle of 11° and manifests in the cylindrical second sleeve 12 in a circular, chamfered end 17. The second sleeve 12 itself is open at this location but is terminated by an Al glass mirror 14. The Al glass mirror 14 may be secured on the chamfered end by way of adhesive bonding, such that the Al glass mirror 14 itself is mounted at an angle with respect to the normal plane of the fiber axis.

A cuboid element 13 encloses the setup as described above from the height of the Al glass mirror 14 to the first sleeve 19. The free section of the glass fiber 11 may be completely isolated from the outside by the sleeves 19, 12 and the cuboid element 13 and the Al glass mirror 14 and the guide element 16, with the result that no disturbing influences act from outside on a measurement. The cuboid element 13 and the sleeve 12 can also be fused to form a single component.

FIG. 2 shows an enlarged illustration, which is not to scale, of the end of the glass fiber 11 in relation to the Al glass mirror 14. The light is reflected at the Al glass mirror 14, and some of the light once again enters the glass fiber 11. The Al glass mirror 14, which in the enlargement shown in FIG. 2 is no longer shown in its entirety, is arranged at an angle 18 of 11° with respect to the normal plane of the glass fiber axis. The distance 21 between the end of the glass fiber 11 and the Al glass mirror 14 in this example is 50 μm.

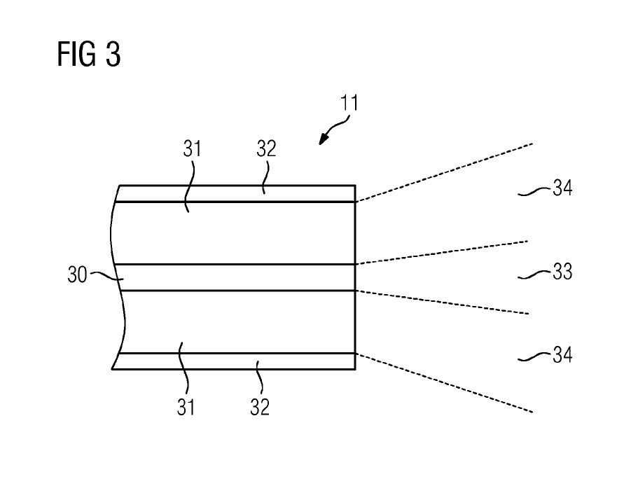

FIG. 3 shows a longitudinal section through the glass fiber 11. The glass fiber 11 comprises a core 30, an internal cladding 31, and an external cladding 32. The multi-mode core shown here has a diameter of 62.5 μm, while the diameter of the internal cladding is 200 μm. The core 30 serves for the guidance of the light to the free end of the glass fiber 11 and thus to the Al glass mirror 14.

The core 30 may have a low numerical aperture and therefore a low emission angle 33. The numerical aperture is here, for example, 0.1. The internal cladding 31 has a greater numerical aperture and therefore has a greater acceptance angle 34 at which light can be coupled in. For example, the numerical aperture is here 0.3. FIG. 3 does not represent the true emission angle or acceptance angle. In the internal cladding, the light beam reflected by the Al glass mirror 14 is coupled in again and guided back to the detector.

In some embodiments, the use and configuration of the glass fiber 11 as double-cladding fiber means that the angle 18 at which the Al glass mirror 14 is tilted relative to the perpendicular arrangement can be increased. Rather than an otherwise preferred angle of, for example, 11°, an angle of 12° or more, in particular 15°, can now be selected. The light output lost is here not as great as it would be if a simple optical fiber were used and is weighed against and superseded by the gain in terms of signal resolution due to the increased angle and the associated increased signal strength in the case of deflection of the glass fiber 11.

What is claimed is:

1. A fiber-optic accelerometer comprising:
an optical fiber having a free end which vibrates under the influence of acceleration;
a light source emitting at least one of visible, ultraviolet, or infrared light into the optical fiber at an opposite end of the fiber;
a mirror arranged to reflect a portion of the light exiting the free end back into the optical fiber; and
a detection device for receiving reflected light at the opposite end of the fiber;
wherein the optical fiber comprises a double-cladding fiber including a core, an internal cladding, and an external cladding.

2. The fiber-optic accelerometer as claimed in claim 1, wherein:
the numerical aperture of the core is between 0.075 to 0.14; and
the numerical aperture of the internal cladding is between 0.22 to 0.5.

3. The fiber-optic accelerometer as claimed in claim 1, wherein the core of the optical fiber contains a Bragg grating at the free end.

4. The fiber-optic accelerometer as claimed in claim 3, wherein both the core and the internal cladding of the optical fiber comprise multi-mode waveguides.

5. The fiber-optic accelerometer as claimed in claim 1, wherein a length of the free end is between 12 and 18 mm.

6. The fiber-optic accelerometer as claimed in claim 1, wherein a termination surface of the free end is formed by a fraction of the optical fiber at an angle of between 5° and 18° with respect to a plane perpendicular to the fiber axis.

7. The fiber-optic accelerometer as claimed in claim 1, wherein tilting axes of the fracture of the optical fiber and of the mirror with respect to a plane perpendicular to the fiber axis are oriented to be parallel with respect to one another.

8. The fiber-optic accelerometer as claimed in claim 1, wherein a distance between the fiber termination surface and the mirror is between 25 μm and 75 μm.

9. The fiber-optic accelerometer as claimed in claim 1, wherein an oscillating weight of the free end of the optical fiber consists only of the weight of the optical fiber.

10. An electrical machine, comprising:
a generator including an end winding;
an optical fiber having a free end which vibrates under the influence of acceleration at the end winding;
a light source emitting at least one of visible, ultraviolet, or infrared light into the optical fiber at an opposite end of the fiber;
a mirror arranged to reflect a portion of the light exiting the free end back into the optical fiber; and
a detection device for receiving reflected light at the opposite end of the fiber;
wherein the optical fiber comprises a double-cladding fiber including a core, an internal cladding, and an external cladding.
